(19) United States
(12) Patent Application Publication
(10) Pub. No.: US 2005/0048279 A1
(43) Pub. Date: Mar. 3, 2005

(54) Composition and methods for applying a scent to an article

(75) Inventors: Patrick L. Watson, Mesquite, TX (US); Joshua L. Hewitt, Mesquite, TX (US)

Correspondence Address: CHALKER FLORES, LLP, 12700 PARK CENTRAL, STE. 455, DALLAS, TX, 75251, US

(73) Assignee: Ekin Group, LLC, Mesquite, TX (US)

(21) Appl. No.: 10/623,281

(22) Filed: Jul. 18, 2003

Related U.S. Application Data
(63) Continuation-in-part of application No. 09/943,792, filed on Aug. 31, 2001, now Pat. No. 6,640,715.

(51) Int. Cl. B05D 3/02; B32B 33/00; B32B 27/18

(52) U.S. Cl. 428/332; 427/372.2; 428/411.1; 523/102

(57) ABSTRACT

The present invention includes compositions and methods for applying a scented gel carrier that includes a scent and a matrix to form a scented gel. After curing, the scented gel carrier is able to maintain its scent following one or more washes in cold water and mild detergent.

### RELATED APPLICATIONS

This patent application relates to U.S. application Ser. No. 09/943,792, filed Aug. 31, 2001, entitled “Wearing Apparel with Scented Ink.”

### TECHNICAL FIELD OF THE INVENTION

The present invention relates in general to compositions and methods for the application of a scent to an article, and more particularly, to a scented gel that is able to maintain a scent on a substrate for extended periods of time when washed one or more times.

### BACKGROUND OF THE INVENTION

Without limiting the scope of the invention, its background is described in connection with scented ink formulations, as an example.

Heretofore, in this field, a scent has been added to an article to enhance its value or use. In other situations, a scent can be used to readily recognize the nature of an article, or the quality of an article. For example, the scent of leather enhances leather furniture, leather wearing apparel, automobile leather seats, and other articles. Indeed, the application of a leather scent to non-leather items, such as vinyl-covered furniture, enhances the marketability of such goods. A cedar scent applied to wood or another covering used in lining a closet enhances the suitability of the closet.

The traditional way of applying a scent to an item is to use a liquid scent and apply the liquid directly to the article. The scented liquid soaks into the surface material of the article and provides an aroma to those in the vicinity of the article. In applying the scented liquid to the article, the liquid is generally applied to the outer, or useful side of the article. In some cases, the scent is encapsulated under a protective cover so as to capture the scent and prevent it from being dispersed until the protective cover is scratched or otherwise broken.

One such scented ink is disclosed in U.S. Pat. No. 6,454,842, to Vernardakis, et al., entitled, “Scented Ink Composition and Method of Preparation” that describes a method of preparing a scented ink composition comprising the steps of first preparing a mixture which includes a polymer component consisting of a water soluble polymer selected from the group consisting of acrylic, styrene-maleic anhydride, sulfonated polyester, polyamide, and polyurethene. A color component is selected from the group consisting of a pigment and a dye, and a solvent component comprising water are also provided. The mixture is then agitated. Finally, an oil-based fragrance is then blended into this mixture to produce a scented mixture and is then agitated. This process, however, requires the addition of volatile organic compounds and ink and cannot be adapted for any product that does not permit a change in color.

In many of the techniques for applying a scent to an article, the scent is applied during the manufacture of the article. Accordingly, once the article has been manufactured, the scent can no longer be applied. For example, U.S. Pat. No. 6,261,347, issued to Moreland entitled, “Scented Jet Ink and Printed Articles Therefrom,” is directed to a scented ink composition suitable for use in ink jet printing which generates aromas during printing and produces scented printed articles such as greeting cards. The Moreland process is limited to ink jet printing that includes an ink and is therefore unsuitable for colorless application and is limited in throughput by the speed of the ink jet apparatus, which also lead to potential leaching and dispersal of the ink.

From the foregoing, it can be seen that a need exists for a new technique for applying a scent to an article.

### SUMMARY OF THE INVENTION

It has been found, however, that the present methods fail to provide a scented gel carrier or matrix that is able to withstand even a single wash. The present inventors have recognized that for a scented article to have a longevity that is more in accord with expected useful life of an item, a scented gel matrix or carrier must be able to withstand one or more washes. Another significant problem of current scented products is that they require that the composition include an ink or be formed as part of a pattern or design.

What is needed is a scented gel carrier or matrix that provides a scent after one or more washings in, e.g., cold water using standard machine washing soap liquid or powder. Also needed is a scented gel carrier or matrix that may be applied and provided without one or more of the following: color (e.g., ink), a pattern, a printer, warming, a beaded insert. In the present invention, the composition, structure and method described herein may be used alone or in combination to provide a scent to an article that is easy to apply and suitable for high throughput machine deposition or even manual deposition.

More particularly, the present invention includes a gel having a scent and a matrix that may be seasoned to form a scented gel, wherein the scented gel maintains its scent following one or more washes in cold water and mild detergent. The present compositions and methods permit the deposition, printing or spraying of the scented gel carrier of the present invention to use scents that are: water-soluble; oil-soluble or even alcohol based. The scent may even be a multi-component scented mixture that may also include, e.g., a deodorizing essence, an antiperspirant and/or antifungal or even anti-bacterial agent(s). The scented gel carrier may be colorless or may contain a pigment, whether intrinsic to the scent, the matrix or added. In one embodiment the scented gel carrier is cured to form a polymer matrix (whether by thermal or chemical crosslinking) that is permanent. For example, the matrix may include one or more monomers that are catalyzable into a polymer by heat and/or chemical reaction. One such matrix may be a plastisol gel, e.g., a high density clear gel.

The scented gel carrier is applied to a substrate and then cured at a temperature that is less than about the flashpoint of the scent. In one example, the curing temperature is five to ten degrees less than the flashpoint of the scent. In other examples, however, it has been found that the curing temperature may exceed the flashpoint of the scent so long as the internal temperature of the scented gel carrier is at, about or less than the flashpoint of the scent regardless of the surface temperature. Generally, a curing temperature of between about 200, 250, 275, 325 or 350 degrees Fahrenheit may be used for most scents, however, the present invention is adaptable for scent having flashpoints below 200 degrees Fahrenheit.

In one important embodiment of the present invention, the scented gel carrier is applied to the back-side or generally non-visible portion of an article that is to be scented. By applying the scented gel matrix to the backside of an article the color and or pigmentation of the scented gel carrier does not affect the appearance of the article. In some cases the thickness of the scented gel carrier may further enhance the article by providing, e.g., cushioning and/or grip. In one example, the scented gel carrier is adapted for deposition from between about 5 to about 800 microns. The scent and the matrix may be provided in a ratio from about 1:50 to about 50:1 (v/v), respectively or if the scent is powdered at the same ratios weight to volume. The scented gel carrier may include a ratio of about 100 parts matrix to about 2 to about 40 parts scent wherein the scented gel has a flash point of up to about 350 Fahrenheit. The scented gel carrier may also include about 5 to about 7 parts of a thickener and about 2 parts catalyst, which are useful to reduce leaching into porous substrates and to increase the strength of the scented gel carrier upon curing.

Another embodiment of the present invention is a scented article that includes a substrate; and a scented gel carrier disposed on or about the substrate having a scent and a polymer matrix, wherein the cured scented gel carrier maintains its scent following one or more washes in cold water and mild detergent. The substrate may be selected from, e.g., the products listed in Table 1. The scented gel may be deposited on a substrate with a thickness of between about 5 and about 800 microns. Furthermore, the substrate may also have disposed thereon a design. A protective layer may also be deposited between the substrate and the scented gel or even directly on the scented gel. The scented gel carrier may have about 100 parts matrix or polymer to about 2 to about 40 parts scent about 5 to about 7 parts of a thickener and about 2 parts catalyst. The scented gel carrier may be deposited using screen printing, spraying or even high speed printing on a line or roller.

The present invention also includes a method for preparing a scented gel composition, that includes the steps of: mixing one or more scents with a matrix to form a scented gel carrier; and allowing the mixture to season for at least about one hour, wherein the resulting seasoned mixture when cured onto a substrate maintains a scent for at least about one, two, four or even twelve weeks. The scented gel carrier may be dispensed onto a continuously moving sheet in a high speed manufacturing line. Generally, the scented gel carrier will have sufficient mechanical integrity to retain its shape under ambient conditions; will release a scent in a manner that substantially preserves the native scent upon release; and may be provided to continuous process in a high speed line. The seasoning of the scented gel carrier may be at least about one hour to about 36 hours prior to application onto a substrate. Curing of the scented gel carrier will generally be at a temperature at or below the flashpoint of the scent, for example, at about 275 F for at least about 15 to 60 seconds. After curing the resulting cured scented gel carrier maintains a scent after at least two washes in cold water followed by air drying.

The present invention also includes a method of applying a scent to an article, including the steps of: applying a scented gel carrier to a substrate; and curing the scented gel carrier at a temperature that is at least about 5 degrees Fahrenheit less than the flashpoint of the scent. Finally, the present invention also includes an article of manufacture made in accordance with the methods disclosed herein.

In accordance with the principles and concepts of the invention, there is disclosed a technique for applying a scent to the unused side of an article, such as the inside surface of a substrate. The scented gel carrier may be applied to the unused side of an article by using screen printing techniques. For example, the screen printed scented gel carrier may even be applied on or about a design to outwardly visible or reverse side of the article. The scented gel carrier may be applied to the article after the manufacture of the article has been completed.

A protective coating may also be applied to a desired area prior to or after deposition of the Ekin Panel to prevent liquids from leaching to or through the substrate. In fact, pigment may be applied onto the Ekin Panel prior to, during or even after curing. When the scented gel carrier is covered by the protective coating, the scent permeates through the protective coating to provide an aroma.

According to yet another feature of the invention, a scented gel carrier is made by using a high density or viscous polymer, and then thinning the polymer with a liquid oil that carries the scent. The resulting mixture can be applied to articles using screen printing techniques, but the viscosity of the scented gel carrier does not bleed through porous articles, such as textiles.

### BRIEF DESCRIPTION OF THE DRAWINGS

Further features and advantages will become apparent from the following and more particular description of the preferred and other embodiments of the invention, as illustrated in the accompanying drawings in which like reference characters generally refer to the same parts, functions or elements throughout the views, and in which:

FIG. 1 is a block diagram of a process according to one embodiment for applying and testing a scented gel carrier to a substrate;

FIG. 2 is a cross-sectional view of a substrate showing the scented gel carrier;

FIG. 3 is another cross-sectional view of a substrate showing scented gel carrier on the back side of the substrate;

FIG. 4 is a cross-sectional view of another embodiment of the present invention in which the scented gel carrier is applied on a design, wherein the scented gel carrier may or may not include color;

FIG. 5 is a cross-sectional view of another embodiment of the present invention in varying levels of thickness, from low to high density scented gel carrier is depicted; and

FIG. 6 shows two substrate panels that form a seam in which the scented gel carrier is deposited or sewn-in.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention and do not delimit the scope of the invention.

The present invention includes compositions and methods for adding scent to an article that is able to withstand one or more wash steps and that may maintain its scent for periods of time sufficient to reach the store-shelf and beyond. Using the compositions and methods of the present invention, it has been found that articles may be scented that maintain their scent for over 18 months and that are able to withstand up to about one to about 6 to 15 wash cycles in cold water with a mild detergent. In some cases, the longevity has been found to be between about 20 to 30 wash cycles. For some substrates 5 6 to 15 washes may equate to about two to four years of use, e.g., car mats, sheets, mattress covers, shower curtains, place mats. The present invention provides a scented gel carrier that may act as a substratum for a pattern or design and that allows for multiple washing and drying.

One such method for applying the scented gel carrier of the present invention is screen-printing, as used on T-shirts, which is a significant value-added printing of art, decoration and/or promotional images onto an already finished good. Generally, the screen-printing process takes place on a round or oval revolving screen-printing press that permits the transfer of an ink through a 100 mesh or less screen by an apparatus that “squeegees” liquid ink through, e.g., a positive imaged meshed screen. The substrate is then cured by exposure to heat and dwell in a belt driven dryer.

There are many applications for the screen-printing, however, the present invention is not limited to screen-printing and may be adapted for use with high-throughput industrial printing-press type processing equipment. Those applications dictate a wide range of substrate to press requirements to facilitate the printing of the design/decoration, art or promotion onto substrates. The requirements of high-throughput presses are addressed by the compositions and methods of the present invention by providing a scented gel carrier that may be used to transfer a scent for long-term use using massive rolls of textiles or synthetic substrates (e.g., carpeting) for both commercial and retail markets. Other examples of textiles or synthetics that may use the present invention include, e.g., bedding, drapery, floor coverings, apparel, woven, (towel and denim, etc.) spun, (silk flowers) knitted and decorative, (bathroom and kitchen accessories) items all in the large roll format. Additionally, there is a hard surface—large format requirement. The scented gel carrier of the present invention may be used for the deposition of Ekin Panels on keyboards, automobile interiors, laminates for wall and furniture coverings and signage.

“Screen-printing” is generally a method for adding value to the usable surface of a substrate by applying ink in the manner of art and/or decoration and accepting the fact the art and/or decoration has a different life span than that of the substrate. Screen printing generally involved adding an ink to a substrate that is cured at 320 Fahrenheit /160 Centigrade at a dwell of 45 seconds to 1 minute or at 1000 degrees at a dwell of 1 second, screen tension 20-24 Newton, various mesh counts.

“Screen-Scenting” is the process by which value is added to an article by infusing a scent via a scented gel carrier, wherein the complete product maintains its scent after washing. The scented gel carrier will generally be adaptable for use with existing parameters of screen printing process.

In traditional “silk printing” or “screen printing,” an ink is forced onto a substrate through a stencil, or “mask,” having a porous screen area configured in the shape of the design to be printed, such as letters or graphic images. The printing substrate may be, e.g., textile (natural or synthetic), paper, metal, ceramic, polymer film and the like. The screen may be a gauze or mesh fabricated from metal, textile fabric such as silk or cotton, or various polymer materials. The mask is generally prepared by coating a screen with a curable composition, curing the composition and finally engraving the design. The engraved areas are generally porous, thereby permitting ink to be forced through the screen onto the printing substrate to print the design.

After printing, the ink on the substrate is cured or hardened by any of several methods such as, for example, exposure of the ink to energy such as heat or radiation (e.g. ultraviolet, electron beam, and the like), evaporation of a solvent in the ink composition, or oxidation hardening of drying oil components, e.g., linseed oil, Tung oil, and the like.

Three main technologies are used as the coatings and inks, and include: solvent borne, water borne, and zero volatile organic compounds (VOC). Solvent borne and water borne systems produce coatings which are washable. Water wash-ability is a desired feature of a coating composition since the coating application equipment needs to be cleaned for reuse. Organic solvents present environmental health concerns, as such, there is an increasing desire to eliminate organic solvents in such compositions.

One particular advantage of the present invention is that it is adaptable to a wide variety of scents and is not limited to those scents that are compatible with the chemistry of inks. Any of a wide variety of scents may be chosen, in fact, the scents used in the examples provided hereinbelow were chosen at random from a possible 4000. All clear gel scent carriers were allowed to cure for 24 hours prior to use. All scented substrates were allowed to air cure for 24 hours before laundry cycle tests.

Another distinct advantage of the present invention is that it is adaptable to a wide substrates for scenting and is not limited to those items, such as clothing, that include a design that is scented. In fact, the present invention is compatible with the chemistry of a wide variety of substrates. As listed in Table 1, the present invention may be used on a wide variety of substrates and for a wide variety of purposes where value is added to an item by providing a pleasing or even a masking scent. Table 1 is merely exemplary of the potential products that may be a substrate for the scented gel of the present invention. Furthermore, the present invention may not only be used to add scent, but may also include antimicrobial agents, e.g., antibiotics or anti-fungal agents that are intended to reduce contamination with pathogenic organisms.

TABLE 1
Substrates for Scented Articles.

| Market | Segment | Item |
|---|---|---|
| Transportation: | Car Seats | Buses |
| Automobiles; boats; planes, | | Cars |
| etc. | | Limousines |
| | | Taxis |
| | Floor Mats | Buses |
| | | Cars |
| | | Limousines |
| | | Taxis |
| | Roof Liner | Buses |
| | | Cars |
| | | Limousines |
| | | Taxis |
| Clothing: | Athletic/workout, | 4^{th} of July |
| Infant, children, adult, male | seasonal, recreational, | Christmas |
| and female; fashion | shorts, caps, shirts, | Easter |
| | t-shirts, | Halloween |
| | | Hunting |
| | | Lingerie/Specialty |
| | | Military |
| | | Promotional |
| | | Sports |
| | | Teachers |
| | | Valentine's Day |
| | Camouflage | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| | Hats/caps | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| | Jeans | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| | Lingerie | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| | Pants | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| | Polo Shirts | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| | Shoes | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| | Sweatbands | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| | T-shirts | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| | Uniforms | Childrens |
| | | Christmas |
| | | Halloween |
| | | Hunting |
| | | Lingerie/Specialty |
| | | Military |
| | | Promotional |
| | | Sports |
| | | Teachers |
| | | Valentine's Day |
| Commercial Buildings | Flowers, e.g., Artificial | Bathroom |
| | | Bedroom |
| | | Entire House |
| | | Kitchen |
| | Carpeting | Airports |
| | | Casinos |
| | | Elevators |
| | | Hotels |
| | | Schools |
| | Draperies | Airports |
| | | Casinos |
| | | Elevators |
| | | Hotels |
| | | Schools |
| Haircare | Bags/cases | Promotional |
| | Towers | Promotional |
| | T-shirts | Promotional |
| Home and Commercial | Artificial Flowers | Bathroom |
| Products | | Bedroom |
| | | Entire House |
| | | Kitchen |
| | Bed Edging | Bathroom |
| | | Bedroom |
| | | Entire House |
| | | Kitchen |
| | Bedspreads | Bathroom |
| | | Bedroom |
| | | Entire House |
| | | Kitchen |
| | Carpeting, e.g., woven, | Bathroom |
| | jute, non-skid, etc. | Bedroom |
| | | Entire House |
| | | Kitchen |
| | | Car, Boat, etc. |
| | Draperies | Bathroom |
| | | Bedroom |
| | | Entire House |
| | | Kitchen |
| | Duvet Covers | Bathroom |
| | | Bedroom |
| | | Entire House |
| | | Kitchen |
| | Lamp Shades | Bathroom |
| | | Bedroom |
| | | Entire House |
| | | Kitchen |
| | Laundry Bags | Bathroom |
| | | Bedroom |
| | | Entire House |
| | | Kitchen |
| | Linens | Bathroom |
| | | Bedroom |
| | | Entire House |
| | | Kitchen |
| | Mattress Covers | Bedroom |
| | Placemats | Bathroom |
| | | Bedroom |
| | | Entire House |
| | | Kitchen |
| | Shower Curtains | Bathroom |
| | | Bedroom |
| | | Entire House |
| | | Kitchen |
| | Tablecloths | Bathroom |
| | | Bedroom |
| | | Entire House |
| | | Kitchen |
| | Throw Rugs | Bathroom |
| | | Bedroom |
| | | Entire House |
| | | Kitchen |
| | Toilet Covers | Bathroom |
| | Towels | Bathroom |
| | | Bedroom |
| | | Entire House |
| | | Kitchen |
| Makeup | Bags/cases | Promotional |
| Perfume | Bags/cases | Promotional |
| | Jeans | Promotional |
| | Towels | Promotional |
| | T-shirts | Promotional |

It has been found that a composition of a scented gel carrier may include a plastisol-type screen print gel, an adhesive or tackifier and a scent, e.g., an oil-, water- or alcohol-based scent. While a variety of gel carriers may be used with the present invention, one such gel matrix or polymer that has found particular utility for use with the present invention is a plastisol gel. Plastisol compositions for use with the present invention include, generally, monoesters of fatty acids containing at least 12 carbon atoms. For use with the present invention, however, conventional plasticizers based on phthalic acid esters, alkyl sulfonic acid esters of phenol or other known plasticizers in plastisol compositions may also be used as a composition of the scented gel carrier depending on the curing temperature and the type of scent used.

There are a number of scents that are presently considered to have beneficial medicinal effects. Such scents can also be applied to articles so that persons in the vicinity thereof can smell the scents and receive the benefits thereof. These scents, many of which are essential oils, include Italian bergamot, Brazilian bois de rose, Moroccan chamomile, cinnamon, Russian clary sage, Spanish eucalyptus, Russian fir needle, frankincense, Florida grapefruit, French lavender, California lemon, West Indian lime, Italian mandarin orange, Spanish marjoram, Musk, Indonesian patchouly, American peppermint, Canadian pine needle, rose, Spanish rosemary, Brazilian tangerine, Australian tea tree, Spanish thyme and Ylang ylang, etc. When used with, e.g., scented flowers, the scent may be selected to match the color and shape of the flower. Scents may even include animal-derived scents when used in, e.g., camouflage for hunting.

While not considered to be exhaustive, other artificial or natural scents that can be employed in connection with screen printing on articles, include the scents of plants, trees, flowers, shrubs, fruits, spices, chocolate, vegetables, kitchens, the outdoors, animals, leather, farms, factories, sea spray, air, machinery, medicinal scents, wood, chemicals, petroleum products, etc.

In accordance with an important feature of the invention, the scent may be applied to the unused, unseen or backside of the article or even on an outwardly visible portion of an article. In this manner, the scent can be applied after manufacture of the article is complete, e.g., on the outside of a sock to provide scent and increase the comfort of the sock when provided as a thick scented gel that provides additional cushion and, for example, may also provide a non-skid surface. Downstream businesses can thus use the principles and concepts of the invention to add value to another party's goods by applying the scent to the unused side of the article. In fact, the composition and methods of the present invention may be used before, during or following the final manufacture of an article without affecting the processing of the item.

In one embodiment, the matrix is a high density clear polymer (e.g., Wilflex® High Density Clear #10009HDC, USA). The high density polymer may be used for special effects in which the pigmentation of the underlying substrate may be enhanced by a high-gloss polymer that can be coated on a wide variety of substrate. In addition to the types of substrates outlined in Table 1, the scented gel carrier may be disposed on, e.g., 100% cotton, cotton blends, acrylic, lycra, polyester blends and uncoated nylon. The scented gel carrier will generally include features such as: good adhesion to fabrics, elongation and stretch, typical wash properties, useful for use with light or dark fabric grounds, may be uses as an overprint clear on printed colors and specialty and special effects inks, e.g., metallic, glitter, glow-in-the-dark, etc.

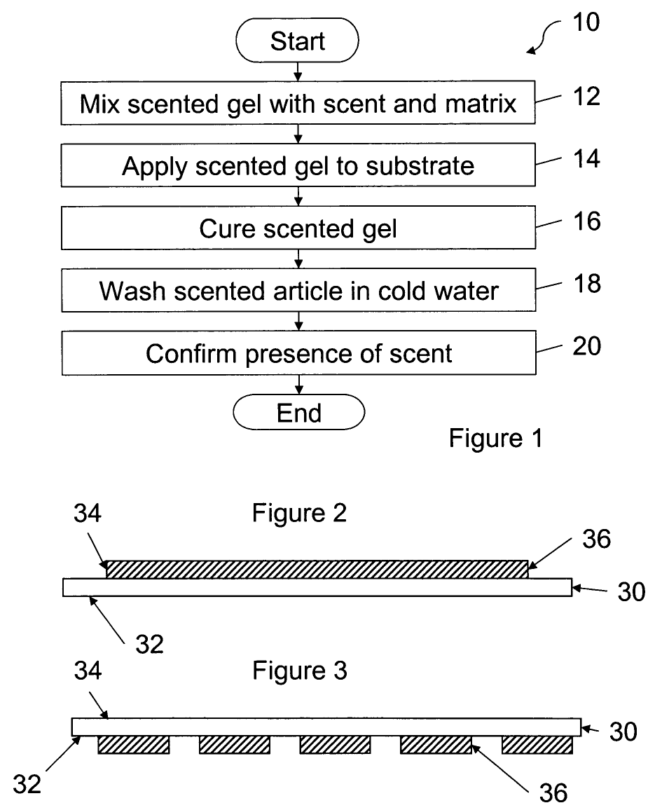

Reference is now made to FIG. 1 of the drawings where there is shown a flow chart of the basic operations 10 of preparing and testing a scented gel carrier. According to an important feature of the invention, the substrate may or may not already have a design preprinted thereon. In fact, in some applications there is no need for a design preprinted thereon. Indeed, the features of the invention allow the article to already have a preprinted design on the outside of the garment, or other type of article. The application of the scent according to the invention does not alter or otherwise adversely affect the preprinted design.

In FIG. 1, step 12, a scented gel carrier is prepared by mixing a scent with a matrix. The basic process for applying and testing the scented gel carrier will be explained at various steps in conjunction with the use of a garment as a substrate, however, no limitation as to the substrate is intended thereby. Generally, the present invention is based in part on the recognition that it is important to match the type of matrix with the type of scent used. In particular, it has been found that the curing temperature of the matrix, e.g., a polymer matrix, will generally be at or below the flashpoint of the scent. As such, it was found that any type of scent, e.g., oil-, water-, alcohol-based may be used with the present invention. Next, in step 14, the scented gel carrier is applied to the substrate, which may be as a clear-coat on the outside of a substrate where the pigmentation, if any, of the substrate is to be maintained. In the case where the scent is itself pigmented, then the scented gel carrier or Ekin Panel may be deposited on the surface of the substrate that will not be visible, e.g., the inside of a garment, in which case the gel carrier may be any color, however, it will generally be a neutral or clear color so that the scented gel carrier is generally undetectable to the eye.

The scented gel carrier of the present invention may be deposited in the form of an Ekin Panel, which is defined herein as a scented gel carrier or matrix that maintains its scent after at least one wash in cold water with a detergent. Depending on the thickness of the gel carrier, e.g., from between about 5 to about 800 or more microns, the cured scented gel will maintain its scent and be detectable at distances of up to 5 feet. In one embodiment, an Ekin Panel scented on a pattern at greater than 600 microns was able to maintain its scent for at least 18 months and was detectable at over 2 feet. In one example of the use of the Ekin Panel, the scented gel carrier is deposited on the inside of a garment to provide the scent without affecting the outward appearance of the garment, that is, there is no outwardly visible sign of the Ekin Panel to the passer-by.

For use with the present invention a number of tackifiers and/or adhesives may be used to provide additional stabilization to the scented gel carrier, e.g., rosins, rosin esters and derivatives thereof. While certain rosin compounds are colored yellow or yellowish brown, when using pigment or when depositing an Ekin panel on the non-visible portion of a substrate, the yellowish color may not be important. Where the rosin resin affects odor, thermal stability and/or weatherability, an unpurified rosin may be hydrogenated to improve stability. Examples of rosin resins, e.g., a hydrogenated methyl esters, such as Hercolyn®, may be used in conjunction with the present invention. Such hydrogenated rosins, or their ester compounds are prepared by esterifying a disproportionated rosin or hydrogenated rosin, both of which are commercially available. Based on the effect on color and scent, different one or more rosin resins and/or derivatives may be selected to achieve satisfactory color tone, stability, and the like.

Generally, the melting or softening point of the rosin resin particles for use with the scented gel carrier will be in the range of 140 to 275 degrees Fahrenheit, depending on the flashpoint of the scent selected and the extent to which the scent will remain in the gel after washing(s), for preservation of the required properties of the scent during storage, and for obtaining a scent with high uniformity.

As the materials for such adhesiveness and/or tackifying properties for use in the scented gel carrier, rosin-type resins such as rosin, polymerized rosin, hydrogenated rosin, rosin ester and hydrogenated rosin ester; terpene resins such as terpene resin, terpene phenol resin, aromatic modified terpene resin and rosin phenol resin; aliphatic, aromatic and alicyclic petroleum resins; and other resins such as cumarone-indene resin, alkyl phenol resin, xylene resin, and low molecular weight (average molecular weight: 1000 or less) styrene resin may also be used.

Another example of the use of the Ekin Panel is to deposit the scented gel carrier on the underside of an object, e.g., the inside of a fitted-sheet or the bottom of a bath or car mat. Such an application is suitable for high-throughput deposition onto an article during processing in a line.

For example, two grams of a liquid oil-based scent are mixed with about 300 grams of a clear plastisol gel to provide a scented gel carrier. Plastisol inks are available in gallons, or other volumes. In one example, using a scented oil is at a concentration of about 6.8%, namely about 6.8 parts (per unit weight) of the scent, and about 93.2 parts (per unit weight) of a petroleum-based carrier. Generally, the same amount of scented oil is used with a given amount of the plastisol ink, irrespective of the type of scent. As will be described below, plastisol is selected because it has a characteristic of a positive hand when applied in thick layers, or with plural thin layers. The present invention may use water-based, alcohol-based and even oil-based scents. Likewise, the polymer that forms the gel may be water-based, alcohol-based and even oil-based and will be selected based on the thickness of the application and its ability to interact with a scent to provide longevity to the scent.

The plastisol gel is mixed in one or more containers and allowed to set for a period of time in a closed container. While not critical, the mixture is allowed to set for about 48 hours. This time period allows the fragrance to permeate the gel carrier and to become a homogenous mixture. Once the mixed containers of the scented plastisol gel carrier have aged for a period of time, the containers are opened and loaded into the respective reservoirs of the stations of a screen print carousel. With such type of automated mechanism, each station is fitted with a mesh screen which may or may not have a stencil design. Silk and other screen materials well known in the art can be used with the invention. While not readily observable, the scented gel carrier may be printed in the design of multiple words of the name of the business applying the scented gel carrier, such as a panel of the words “Ekin,” where the business applying the scented gel carrier to the garment is “Ekin Group, LLC.” Application of the scented gel carrier may be, e.g., a stenciled screen of the same type is coupled to the particular reservoir of scented screen print gel carrier. In this screen printing process, each garment is only screen printed once and not multiple times. At each station of the carousel there is a gel carrier applying mechanism to force the scented gel carrier through the stenciled screen onto the underlying garment. The dwell time for each garment at a respective station of the carousel is about two seconds. In the case of a screen scenting process that includes multiple application steps, the screens may be loaded into the respective stations. In the event that it is desired to flash cure one color during the printing process, then a high temperature dryer can be installed in a station that comes after the material to be flash cured.

In Step 16, the scented gel is cured at a temperature of at least 10 degrees Fahrenheit less than the flashpoint of the scent, for a dwell time of at least about 1 to 3600 seconds. This is believed to be a sufficient time to set the matrix portion of the scented gel carrier so that subsequent process steps can be quickly carried out. Following curing of the scented gel carrier an additional protective coating may be applied to the scented gel carrier, which may also be flash-dried to set the coating and allow the subsequent process steps to be carried out.

In a scent screening process, the process continues by loading the garments, either manually or automatically, onto the garment carriers of the carousel equipment. As the carousel garment carriers rotate and move into a position adjacent a print screen, the carriers stop for about two seconds for printing the article with the scented gel carrier that was loaded into the station. The silk screen loaded into the station associated with the scented gel carrier is adapted for allowing the scented gel carrier to be applied over the protective base. Using the compositions and methods described herein when applying an 800 micron, high density scented gel carrier onto a garment, scent is maintained for over 18 months, with a distance of scent detection in excess of 12 inches.

If the scented gel carrier requires a flash cure, then a carousel station is fitted with a heater that provides heated air at a temperature of about 1,100 degrees Fahrenheit. Many types of screen printing carousels are designed so that each station can be fitted with printing apparatus, heaters, etc., all that are interchangeable when needed.

Rather than being flash dried at a carousel station, the garments may be routed to an in-line furnace or dryer where a temperature of about 325 degrees Fahrenheit is maintained. The temperature is lower than the 375 degrees typically used with in-line furnaces to cure the plastisol gel carrier. By using a lower temperature, less scent is released during this stage of the process, and thus more scent is available in the finished product. The garments pass through the dryer on a wire conveyor and are maintained at such temperature for about 45 seconds. Once the scented gel carrier that is screened on the backside of the garments has cured, the garments are gathered, either manually or automatically, and packaged for shipment.

In steps 18 and 20, the durability of the scent is tested by washing the scented gel carrier that has been cured onto a substrate, in this example a garment, by washing for a complete cycle in cold water in the presence of a mild detergent. The garment is allowed to air dry and the continuing presence of scent is determined by olfactory detection. It has been found, in fact, that scented garments that are properly maintained are able to maintain scent for over one, five, ten, fifteen, twenty or even fifty such washes.

FIG. 2 is a cross-sectional view of a substrate 30 having a first surface 32 and a second surface 34 onto which a scented gel carrier 36 has been applied as a single layer. It has been found that the extent to which the scented gel carrier permeates through the substrate does not generally affect the extent, strength and durability of a scent of the scented gel carrier 36. Substrate 30 material may even be porous to the scent produced by the scented gel carrier. In the example, the substrate 30 may be wearing apparel, such as a T-shirt in which the first surface 32 is the back-side of the textile material and the second surface 34 is the outwardly visible or front-side of the garment. It has been found that when a scented gel carrier is made with a higher viscosity than typically used in the screen printing industry, the protective coating is not necessary. The viscosity of the scented gel carrier itself prevents the gel from being pressed through the fibers of the garment. The scented gel carrier thus remains on the surface of the porous article without bleeding through to the other side. Plastisol polymer materials conventionally used as a color base in screen printing processes have a viscosity that is greater than that of the scent. When gel carriers of these viscosities are mixed with liquid scents, the resulting viscosities are reduced to an extent that the scented gel carrier 36 bleeds through porous materials. Bleed through of the gel carrier is undesirable as the design or shape of the gel carrier pattern may be slightly visible on the frontal or usable side of the article.

Plastisol polymers used in screen printing equipment can be specially ordered with increased densities from suppliers of plastisol ink materials. A plastisol of the viscosity noted above is not itself well adapted for use in screen printing, however, when mixed with a scented oil in the proportion noted above, the resulting mixture has a viscosity sufficiently high such that the mixture does not bleed through porous material, such as T-shirt and other similar materials. Scented gel carriers of other viscosities may be used with other porous articles to prevent bleed-through.

FIG. 3 is a cross sectional view of another embodiment of the present invention in which the scented gel carrier is applied onto the substrate on surface 32. In the case of a screen printing process of a garment that serves as the substrate 30, for example, the garment may be turned inside-out. In other words, the side of the garment that is generally seen or exposed is turned to the inside. In this manner, the inside of the garment is now on the outside and is exposed for applying the scented materials thereto. In articles other than garments, such as pillow cases and the like, they can also be turned inside out so that the scented gel carrier 36 can be applied to the unused or unseen surface. On the other hand, some articles may have an unused or unseen side, but may not need to be turned inside out. For example, a roll of upholstery or a sheet material for use in making automobile seats or floor mats may simply be scent screened on the backside without turning the material inside out.

FIG. 4 is a cross-sectional view of a scented gel carrier 36 that is deposited on an intermediate coating 38, which may be a protective coating base that prevents the scented gel carrier 36 from bleeding or otherwise leaching through the substrate 30. The transfer of the scented gel carrier 36 through a porous material can occur if the viscosity of the gel carrier is too low. The intermediate coating 38 is generally a liquid or aerosol material that is applied to the panel or area of the material to which the scented gel carrier will be applied and may even include a design that may or may not be pigmented. In one such implementation, the scented gel carrier 36 may be clear or even have some pigment that affects in combination with the pigmentation of the intermediate coating 38 may yield new color. It is contemplated that a intermediate coating 38 may be, e.g., ScotchGuard® used with equal effectiveness. Indeed, if gel-type protective bases are used, such gels may be applied at a station of the screen printing carousel.

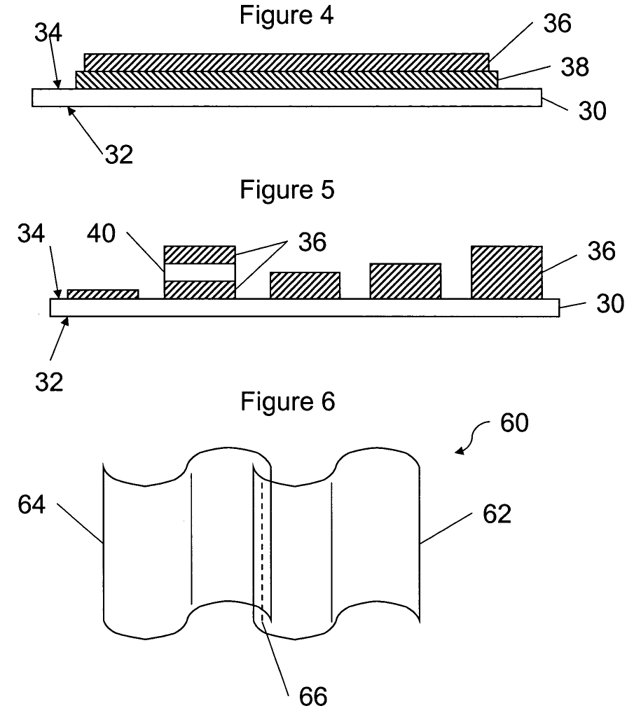

FIG. 5 is a cross-sectional view of yet another embodiment of the present invention which depicts several types and thicknesses of deposition of the scented gel carrier 36. For example, the scented gel carrier may be deposited in a wide variety of thicknesses and may even have dispersed or deposited within two scented gel carrier 36 layers an intermediate layer 40, which may be, e.g., a protective layer, a design, or even a different gel carrier with a different scent. The use of the higher viscosity plastisol polymer as a base material allows the application of the scented gel carrier 36 to an article to be more economical, in that no protective coating is needed, nor the time for drying of the protective coating.

The scented gel carrier 36 can be applied to the unused portion of many articles, thus adding value to manufactured articles. Indeed, the scented gel carrier 36 can also be incorporated into articles as they are being manufactured. As an example, the scented gel carrier 36 may be applied to a seam in a garment before sewn together or may even be applied to the thread that is used to create the seam as it is sewn. The seam may be of many types, e.g., the seam may have first and second panels 62 and 64, respectively, are fastened by a thread 66. When finalized, the flaps of the seam may be ironed flat against the fabric panels. Alternatively, a bead of scented gel carrier (not depicted) may be applied to one or both edges of the fabric panels 62, 64.

The bead of scented gel may be applied during the fabric sewing or cutting operation, may be ironed-on, may be deposited or may even be printed into one or both of the fabric panels 62, 64. The bead of scented gel may be applied manually using a pliable container with a dispenser spout having a small opening, or may even be in the form of staples. In one method application, the scented gel may even be applied from a mechanical or hand-held dispenser that delivers the scented gel to the desired location. In fact, the present invention may even be provided in a sealed container for household use in which the scented gel carrier is cured by using, e.g., a hot air gun. The scented gel carrier may be dispensed manually on the edge of the fabric where the scent is to be placed.

The scented gel carrier may be applied automatically during different fabric processing operations. Indeed, fabric cutting equipment may be augmented with a scented gel carrier application nozzle to accomplish both operations at the same time. Sewing machines may be equipped, e.g., with scented gel carrier dispensers to deposit a bead of the mixture along a line to be sewn. When the scented gel carrier 60 is applied during the seam-making operation of a garment, the scent is incorporated into the garment during manufacture thereof. The thread can be soaked in a scented gel carrier and allowed to cure prior to use in the sewing operation. For example, the scent may be added to monomers of vinyl acetate monomer (VAM) prior to polymerization into a polyester or other like synthetic material.

In articles that do not have a frontal design the Ekin Panel may be varied as a function of the size and shape of the article, as well as the amount of aroma to be emitted from the article. The Ekin Panel is essentially any size and shape on an area of the surface of a substrate to which the scented composition is to be applied, e.g., the scented gel carrier may be screen printed in the design of the words “Ekin” that is repeated across the entire area of the Ekin Panel 74. Since the scented gel carrier is on the inside or underside of a substrate or article it is undetectable.

In order for the aroma of the scented composition to permeate through the material of the article, the material should generally be porous or permeable to the fragrance. The application of the scented composition to the unused or backside of the article can be accomplished with numerous articles, as set forth as examples in Table 1, and may include wearing apparel of all types, whether sports wear, underclothing, suits, shirts, coats, gloves, belts, hats and caps, scarves, shoes, slippers, etc. The scented gel carrier may also be applied to a host of other articles, such as carpets, rugs, sheets, pillow cases, towels, blankets, curtains, table cloths, place mats, wall coverings for rooms, upholstery, e.g., automobile upholstery, furniture, e.g., cloth or other coverings (e.g., canvas, patio furniture, umbrellas, hammocks), luggage, tents, flowers, etc.

The following examples show the composition and operation of the method of the present invention, as well as the development of the final product. The description uses, but is not limited to, the deposition, curing and testing of the scented gel carrier of the present invention on an article of clothing in conjunction with screen printing. Table 2 contains a number of scents that may be used with the present invention, including their flashpoints. While any number of sources for scents may be used, a particular source for a wide variety of scents is Creative Fragrances, Dallas, Tex.

TABLE 2
Examples of Scents and their Flashpoints.

| SCENT | FP | |
|---|---|---|
| Almond (Strong sweet cherry almond) | 145 | F. |
| Aloe Vera (Green herbaceous) | 165 | F. |
| Amaretto Coffee (Cherry coffee chocolate) | 190 | F. |
| Amber (Strong sweet powdery amber) | >200 | F. |
| Ambrosia (Vanilla mulberry) | 140 | F. |
| Angel Dust (Sweet floral musk vanilla) | >200 | F. |
| Angel Feathers (Sweet fresh clean floral musk) | 172 | F. |
| Angel Mint (Strong sweet musky mint) | 195 | F. |
| Angel Wings (Sweet floral musk amber) | >200 | F. |
| Apple (Red Delicious type) | >200 | F. |
| Apple (Red Delicious peel type) | 160 | F. |
| Apple (McIntosh Red type) | 140 | F. |
| Apple Blossom (Sweet heady apple floral) | 195 | F. |
| Apple Blossom (Strong sweet fruity apple floral) | 162 | F. |
| Apple Butter (Slightly tart spicy apple) | 190 | F. |
| Apple Cinnamon (Sweet fresh cinnamon apple) | 155 | F. |
| Apple Crisp (Strong warm baked apple cinnamon) | 151 | F. |
| Apple Jack (Apple cider cinnamon) | 150 | F. |
| Apple Jack & Peel (Sweet apple citrus spice) | >200 | F. |
| Apple Pie (Sweet pecan caramel apple spice) | 185 | F. |
| Apple Pie (Sweet cinnamon apple pie crust) | 174 | F. |
| Apple Spice (Sweet spicy apple - Apple Cider) | 190 | F. |
| Apple Spice (Sweet apple cinnamon clove) | >200 | F. |
| Apricot Mint (Strong sweet fruity apricot mint) | 160 | F. |
| Apricot Nectar (Sweet sumptuous apricot) | 155 | F. |
| Autumn (Sweet fresh citrus floral) | 155 | F. |
| Azalea (Sweet woody floral) | 167 | F. |
| Azalea (Higher F.P. version) | 195 | F. |
| Baby Magic Type (Rose baby powder) | >200 | F. |
| Baby Powder (Sweet powdery aldehydic) | 186 | F. |
| Baked Apple (Sweet apple spice) | 165 | F. |
| Baked Apple (Sweet cinnamon apple) | 179 | F |
| Banana (Sharp sweet banana fruity) | 141 | F. |
| Banana Cream Pie (Sweet vanilla banana) | 155 | F. |
| Banana Nut Bread (Strong sweet nutty banana) | >200 | F. |
| Bayberry (Strong herbaceous green fir) | 168 | F. |
| Bergamot Blossom (Fresh clean bergamot floral) | 141 | F. |
| Birthday Cake (Sweet vanilla sl cherry cake) | 145 | F. |
| Black Cherry (Sweet Leudens cherry type) | 140 | F. |
| Black Cherry (Higher F.P. version) | 152 | F. |
| Black Currant (Sweet fruity strawberry currant) | 145 | F. |
| Blueberry (Heavy sweet syrupy) | 158 | F. |
| Blueberry (Blueberry fruit) | 170 | F. |
| Blueberry Muffin (Strong sweet muffin/cobbler) | 186 | F. |
| Blueberry Pie (Sweet fruity blueberry pie) | 170 | F. |
| Bluebonnet (Heavy sweet sl. green floral) | >200 | F. |
| Bluebonnet (Fresh sweet floral) | 195 | F. |
| Bourbon Whiskey (Strong sharp whiskey) | 150 | F. |
| Briarwood (Woody sweet Patchouli floral) | 200 | F. |
| Brown Sugar (Very sweet sl. maple sugary) | >200 | F. |
| Bubble Gum (Strong sweet fruity bubble gum) | 145 | F. |
| Buttercream (Heavy very sweet buttery vanilla) | >200 | F. |
| Buttercream Crunch (Very sweet maple sugar) | >200 | F. |
| Butterscotch (Powerful sweet butterscotch) | 148 | F. |
| Cactus Flower (Floral woody herbaceous) | 150 | F. |
| Cake (Sweet moist yellow cake) | 176 | F. |
| Cake (Sweet vanilla caramel cake) | 172 | F. |
| Café au Lait (Coffee & cream) | >200 | F. |
| Café au Lait (Strong creamy coffee) | >200 | F. |
| Camellia (Sweet heavy camellia sweet pea floral) | >200 | F. |
| Candy Apple (Sweet vanilla apple cinnamon) | 160 | F. |
| Candy Cane (Vanilla peppermint) | 160 | F. |
| Candy Corn (Very sweet vanilla) | 164 | F. |
| Cantaloupe (Sweet fruity cantaloupe) | 149 | F. |
| Cappuccino (Cinnamon coffee) | >200 | F. |
| Caramel (Sweet caramel sugar) | >200 | F. |
| Carnation (Heavy sweet carnation floral) | >200 | F. |
| Carnation (Sweet spicy carnation floral) | >200 | F. |
| Carrot Cake (Sweet fresh spicy carrot cake) | >200 | F. |
| Cedar (Cedarwood) | >200 | F. |
| Chamomile (Green woody herbaceous floral) | 193 | F. |
| Cherry (Strong sweet cherry) | 140 | F. |
| Cherry Blossom (Sweet slightly spicy floral) | 155 | F. |
| Cherry Limeade (Sweet cherry lime) | 145 | F. |
| China Berry (Sweet fruity berry musk floral) | 151 | F. |
| China Rain (Floral musk hyacinth muguet) | >200 | F. |
| Chocolate (Strong rich sweet milk chocolate) | >200 | F. |
| Chocolate Cherries (Rich chocolate cherry) | 190 | F. |
| Chocolate Chip Cookies (Sweet choc. cookie) | 190 | F. |
| Chocolate Mint (Sweet chocolate peppermint) | 176 | F. |
| Chocolate Raspberry (Sweet choc. fruity rasp) | 190 | F. |
| Christmas Berry (Hollyberry cinnamon orange) | 151 | F. |
| Christmas Scent (Orange cinnamon) | 148 | F. |
| Christmas Tree (Douglas Fir) | 153 | F |
| Cider (Apple cider - apple cinnamon) | 155 | F. |
| Cinnamon (Red Hot) | >200 | F. |
| Cinnamon (Sweet) | 186 | F. |
| Cinnamon Bun (Sweet cinnamon vanilla) | >200 | F. |
| Cinnamon Spice (Sweet cinnamon clove spice) | >200 | F. |
| Cinnamon Sticks (Sweet cinnamon cookie/cake) | >200 | F. |
| Citronella (Strong heavy sweet citrus floral) | 180 | F. |
| Citrus (Orange lemon lime grapefruit) | 138 | F. |
| Clove (Sweet spicy clove) | 194 | F. |
| Clover Meadow (Strong heavy sl. powdery floral) | 180 | F. |
| Cocoa (Cocoa chocolate) | >200 | F. |
| Coconut (Dry) | >200 | F. |
| Coconut (Fresh & clean) | >200 | F. |
| Coconut (Sweet) | >200 | F |
| Coconut Cream Pie (Vanilla coconut) | >200 | F. |
| Coffee (Powerful rich sweet Columbian coffee) | >200 | F |
| Cookie Dough (Very sweet vanilla cookie dough) | 164 | F. |
| Country Spice (Cinnamon spice orange vanilla) | 151 | F. |
| Country Spice (Clove allspice cinnamon) | 199 | F. |
| Country Vanilla (Vanilla bean slightly spicy) | 140 | F. |
| Cranapple (Sweet fruity apple cranberry) | 155 | F. |
| Cranberry (Sharp tart cranberry fruity) | 141 | F. |
| Cranberry (Sweet fruity cranberry raspberry) | 160 | F. |
| Cranberry Spice (Sweet fruity cinnamon clove) | 141 | F. |
| Creamy Vanilla (Very sweet sl buttery vanilla) | 195 | F. |
| Creamy Vanilla (Same as #7128 but more soluble) | 195 | F. |
| Creamy Vanilla (Very sweet buttery vanilla) | >200 | F. |
| Crème Brulee (Vanilla burnt sugar cream) | >200 | F. |
| Cucumber (Green cucumber) | 178 | F. |
| Cucumber (Fresh green watery) | >200 | F. |
| Cucumber Melon (Fresh green cucumber melon) | 160 | F. |
| Cucumber Rose Melon (Green rosy melon) | 152 | F. |
| Cut Grass (Powerful penetrating green grass) | 197 | F. |
| Daffodil (Spicy floral muguet carnation) | 170 | F. |
| Daisy Fresh (Sweet citrus powdery floral) | 137 | F. |
| Dark Musk (Sweet amber woody musk) | >200 | F. |
| Deck The Halls (Orange spice) | 140 | F. |
| Desert Rose (Dry sweet spicy rose) | >200 | F. |
| Desert Sage (Sweet woody herbaceous sage) | 160 | F. |
| Dogwood (Green earthy spicy floral) | 192 | F. |
| Dragons Blood (Sweet citrus woody amber) | 170 | F. |
| Dreamcicle (Orange Vanilla) | 150 | F. |
| Dutch Apple (Sweet spicy apple) | 155 | F. |
| Earth (Just like dirt) | >200 | F. |
| Egg Nog (Sweet spicy ginger vanilla) | 177 | F. |
| Egyptian Musk (Sweet warm musk) | >200 | F. |
| Eucalyptus (Strong sweet medicinal herbaceous) | 157 | F. |
| Eucalyptus (Noxzema type) | 152 | F. |
| Evergreen (Sweet piney) | 160 | F. |
| Fern (Green piney fern) | 162 | F. |
| Fir (Green sweet fir balsam Christmas tree) | 158 | F. |
| Fireplace (Smokey woody fireplace) | 193 | F. |
| Flower Shop (Green rose jasmin hyacinth) | 200 | F. |
| Frangipani (Woody floral honeysuckle lily) | 184 | F. |
| Frankincense (Sweet woody herbaceous) | 195 | F. |
| Frankincense & Myrrh (Sweet woody musky) | >200 | F. |
| Freesia (Earthy citrus floral) | 145 | F. |
| Freesia (Higher F.P. version) | 165 | F. |
| Freesia Sweet (Vanilla freesia) | 165 | F. |
| French Market (Sweet floral tuberose gardenia) | 160 | F. |
| French Vanilla (Sweet sl. spicy vanilla) | 162 | F. |
| Fresh Fruit (Sweet apple pear fruity) | 195 | F. |
| Fresh & Clean (Citrus marine floral musk) | 170 | F. |
| Gardenia (Sweet gardenia honeysuckle floral) | 190 | F. |
| Gardenia (Strong sweet gardenia floral) | 200 | F. |
| Gardenia (Sweet heavy sultry gardenia)) | 186 | F. |
| Geranium (Strong earthy herbaceous geranium) | >200 | F. |
| Ginger (Strong spicy ginger) | >200 | F. |
| Gingerbread (Sweet ginger vanilla) | 160 | F. |
| Ginger Peach (Fresh fruity peachy ginger spice) | 180 | F. |
| Ginger Spice Oatmeal (Ginger oatmeal) | 225 | F. |
| Ginger Vanilla (Sweet vanilla ginger spice) | 190 | F. |
| Golden Maple Syrup (Powerful sweet maple) | >200 | F. |
| Graham Cracker (Strong sweet graham cracker) | >200 | F. |
| Grape (Sweet Concord grape) | 140 | F. |
| Grapefruit (Citrus tart grapefruit) | 140 | F. |
| Green Apple (Strong tart green apple) | 160 | F. |
| Green Apple (Fresh green herbal apple) | 158 | F. |
| Green Tea (Tart green floral tea) | 170 | F. |
| Green Tea (Spicy bergamot floral tea note) | 175 | F. |
| Guava (Sweet tropical papaya strawberry fruity) | 160 | F. |
| Guava Tangerine (Sweet tropical citrus fruity) | 153 | F. |
| Harvest (Cinnamon green apple van. pine spice) | 141 | F. |
| Hawaiian (Sweet citrus pineapple coconut) | 151 | F. |
| Hazelnut (Roasted hazelnut) | 178 | F. |
| Hazelnut Coffee (Strong hazelnut coffee) | >200 | F. |
| Heather (Sweet woody herbaceous floral) | 170 | F. |
| Heather Hyacinth (Strong green spicy floral) | 200 | F. |
| Herbal (Sweet Herbal Essence type) | 193 | F. |
| Holiday Memories (Orange cinnamon) | 160 | F. |
| Holiday Spirit (Apple pear musk) | 187 | F. |
| Hollyberry (Pine floral spice) | 155 | F. |
| Home for the Holidays(Sweet spicy apple peach) | 160 | F. |
| Honey Almond (Strong honey cherry almond) | 149 | F. |
| Honeydew Melon (Green) | 158 | F. |
| Honeydew Melon (Fruity) | 150 | F. |
| Honeysuckle (Sweet honeysuckle floral) | >200 | F. |
| Honeysuckle (Green honeysuckle lily floral) | 187 | F. |
| Hot Baked Apple Pie (Just like it sounds) | 153 | F. |
| Hyacinth (Strong green hyacinth floral) | >200. | |
| Hydrangea (Strong green spicy powdery floral) | 190 | F. |
| Icicle-Angel Feathers(Sweet fresh clean floral musk) | 172 | F. |
| Iris (Orris) (Sweet amber orris woody floral) | >200 | F. |
| Iris (Sweet heavy green iris floral) | >200 | F. |
| Irish Cream (Very sweet cream coffee) | >200 | F. |
| J&J Type Baby Powder (Sweet powdery floral) | 194 | F. |
| Jasmine (Soft jasmine petals) | 196 | F. |
| Jasmine (Heavy sweet creamy jasmine) | 198 | F. |
| Jasmine (Light green jasmine flower) | 196 | F. |
| Jasmine (Sharp heady green jasmine flower) | 170 | F. |
| Jasmine (Strong heavy concentrated jasmine) | 185 | F. |
| Juniper (Sharp fresh green juniper fir woody) | 135 | F. |
| Juniper Breeze (Sweet fruity juniper) | 150 | F. |
| Kaluha Café au Lait (Chocolate coffee cream) | >200 | F. |
| Key Lime Pie (Sweet lime pie) | 150 | F. |
| Kiwi (Sharp green fruity kiwi) | 145 | F. |
| Kiwi Strawberry (Sweet fruity kiwi strawberry) | 140 | F. |
| Lavender (Strong spicy lavender herbaceous) | 172 | F. |
| Lavender (Soft warm woody lavender) | 195 | F. |
| Lavender Blossom (Sweet herb. lavender floral) | 148 | F. |
| Lavender Mint (Powerful sweet lavender mint) | 159 | F. |
| Lemon (Fresh clean lemon fruit) | 150 | F. |
| Lemon (Lemon drop candy - sweet lemon juice) | 146 | F. |
| Lemon (Strong fresh sweet lemon peel) | 150 | F. |
| Lemon Chiffon (Sweet lemon vanilla) | 175 | F. |
| Lemon Flower (Sweet fruity citrus floral) | 140 | F. |
| Lemon Pie (Sweet lemon vanilla pie crust) | 143 | F. |
| Lemongrass (Strong heavy sweet grassy lemon) | 160 | F. |
| Lemon Spice (Cinnamon clove spicy lemon) | 175 | F. |
| Lilac (Sweet spicy lilac) | >200 | F. |
| Lilac (Heavy sweet lily lilac) | >200 | F. |
| Lilac (Sweet lilac honeysuckle floral) | 190 | F. |
| Lilac (Sweet warm lilac floral) | >200 | F. |
| Lily (Stargazer) (Clean fresh lily lilac) | >200 | F. |
| Lily of the Valley (Heavy sweet green lily muguet) | >200 | F. |
| Lime (Sweet fresh lime) | 140 | F. |
| Lime Sherbet (Fresh sweet lime vanilla) | 146 | F. |
| Linen (Fresh clean warm linen floral) | 160 | F. |
| Linen (Sweet clean fruity warm linen) | 160 | F. |
| Lotus Blossom (Sweet floral rose lilac) | >200 | F. |
| Magnolia (Mild sweet warm magnolia floral) | 185 | F. |
| Mango (Sweet citrus fruity berry) | 138 | F. |
| Mango Melon (Sweet fruity berry melon) | 160 | F. |
| Maple (Powerful sweet sticky maple vanilla) | >200 | F. |
| Marzipan (Sweet vanilla almond) | 155 | F. |
| Mediterranean Fig (Sweet fruity green fig) | 165 | F. |
| Melon (Sweet melon honeydew cantaloupe) | 145 | F. |
| Melon (Strong sweet honeydew cantaloupe) | 153 | F. |
| Merry Berry (Mulberry strawberry cranberry) | 145 | F. |
| Milk (Sweet vanilla milk) | 190 | F. |
| Mimosa (Strong sharp heavy spicy mimosa floral) | 190 | F. |
| Mint (Strong wintergreen peppermint spearmint) | 185 | F. |
| Mistletoe (Strong sweet fruity pine) | 148 | F. |
| Mocha (Strong chocolate coffee) | >200 | F. |
| Morning Glory (Strong sweet spicy green floral) | >200 | F. |
| Mountain Green (Green piney herbaceous) | 168 | F. |
| Muguet (Strong sweet rosy lily floral) | >200 | F. |
| Mulberry (Strong tutti fruity berry) | 143 | F. |
| Mulberry (Strong fruity cherry mulberry) | 141 | F. |
| Mulberry Spice (Spicy fruity mulberry) | 141 | F. |
| Muscadine (Strong sweet grapy fruity) | 160 | F. |
| Muscadine (Strong grape mulberry) | 137 | F. |
| Musk (Strong rich woody herbaceous musky) | >200 | F. |
| Myrrh (Sweet warm woody musky) | >200 | F. |
| Myrrh (Sweet nutty earthy myrrh) | >200 | F. |
| Myrrh (Heavy sweet musky woody) | >200 | F. |
| Nag Champa(Sweet woody powder floral incense) | 187 | F. |
| Narcissus (Strong green narcissus ylang floral) | 190 | F. |
| Narcissus (Heavy woody narcissus floral) | 198 | F. |
| Neroli (Sweet orange flower) | 171 | F. |
| New Mown Hay (Strong sweet herbaceous floral) | 193 | F. |
| Noel (Pine Orange Spice) | 141 | F. |
| Oakmoss (Green earthy oakmoss - green color) | >200 | F. |
| Oatmeal Milk & Honey (Sweet honey vanilla) | 135 | F. |
| Oatmeal Raisin Cookie (Sweet spicy cookie) | 167 | F. |
| Ocean Breeze (Heavy ocean muguet floral) | >200 | F. |
| Orange (Sweet orange peel) | 146 | F. |
| Orange Blossom (Sweet sultry orange flower) | 140 | F. |
| Orange Clove Pine | 145 | F. |
| Orange Cranberry (Strong fruity orange cran.) | 136 | F. |
| Orange Spice (Sweet orange juice clove spicy) | 141 | F. |
| Orange Vanilla (Strong sweet vanilla orange) | 142 | F. |
| Papaya (Sweet fruity citrus tropical) | 165 | F. |
| Papaya Mango (Sweet citrus fruity tropical) | 152 | F. |
| Passion Flower (Sweet fruity floral) | 155 | F. |
| Patchouli (Strong sweet rich woody patchouli) | 200 | F. |
| Fresh Peach (Fresh clean peach fuzz) | 148 | F. |
| Fruity Peach (Heavy sweet syrupy peach) | 188 | F. |
| Sunripened Peach (Strong tart peach pit) | 158 | F. |
| Peaches & Cream (Sweet creamy vanilla peach) | 180 | F. |
| Peach Pecan (Sweet fruity peach maple vanilla) | 160 | F. |
| Peanut (Strong sweet nutty) | >200 | F. |
| Pear (Strong fresh clean pear fruit) | 145 | F. |
| Pear (Sweet juicy pear) | 160 | F. |
| Pear Berry (Sweet fruity pear mixed berry) | 145 | F. |
| Pear Glace (Sweet fruity pear) | >200 | F. |
| Pecan Pie (Powerful sweet maple pecan vanilla) | 162 | F. |
| Peony (Heavy sharp woody jasmine floral) | 190 | F. |
| Peppermint (Warm sweet minty) | 169 | F. |
| Pina Colada (Strong sweet coconut pineapple) | 180 | F. |
| Pine (Sweet pine tree) | 140 | F. |
| Pineapple (Strong sharp tart pineapple) | 145 | F. |
| Pineapple (Sweet pineapple juice) | 145 | F. |
| Pinion (Sweet earthy pinion pine) | 190 | F. |
| Pistachio Nut (Sweet cherry nutty) | 174 | F. |
| Plum (Strong fruity plum) | 165 | F. |
| Plumeria (Strong fruity green floral) | >200 | F. |
| Plumeria (Sweet fruity musky floral) | 185 | F. |
| Plumeria Sweet (Sweet soft fruity floral) | >200 | F. |
| Pomegranate (Strong fruity berry) | >200 | F. |
| Popcorn (Strong sweet buttery popcorn) | 144 | F. |
| Potpourri (Sweet spicy citrus herbaceous floral) | 160 | F. |
| Pound Cake (Sweet vanilla yellow cake) | 184 | F. |
| Primrose (Dry woody rose floral) | >200 | F. |
| Pumpkin (Sweet pumpkin custard) | 155 | F. |
| Pumpkin Harvest (Citrus clove spicy pumpkin) | 142 | F. |
| Pumpkin Pie (Sweet spicy pumpkin pie) | 140 | F. |
| Pumpkin Spice (Sweet spicy vanilla pumpkin) | 195 | F. |
| Rain (Strong clean aldehydic herbaceous ozone) | 142 | F. |
| Rain Forest (Sweet herbaceous piney forest) | 172 | F. |
| Rain Fresh (Strong fresh citrus woody floral) | 183 | F. |
| Raspberry (Strong sharp fruity raspberry) | 160 | F. |
| Raspberry (Strong sweet fruity berry - sunripened) | 185 | F. |
| Raspberry Lemonade (Sweet lemon lime rasp.) | 141 | F. |
| Raspberry Sage (Sweet fruity rasp. herb. sage) | 156 | F. |
| Red Currant (Sweet fruity strawberry currant) | 190 | F. |
| Red Velvet Cake (Sweet creamy spicy cake) | >200 | F. |
| Roasting Chestnuts (Strong sweet nutty) | 148 | F. |
| Roasting Chestnuts Maple (Sweet maple nutty) | >200 | F. |
| Rocky Road (Sweet chocolate nutty vanilla) | 200 | F. |
| Romantic Garden (Strong rose jasmine green) | >200 | F. |
| Rootbeer (Strong sweet rootbeer) | 186 | F. |
| Rose (Strong rich true red rose) | >200 | F. |
| Rosemary (Sharp medicinal herbaceous) | 166 | F. |
| Rose Raspberry (Fruity rose raspberry) | 200 | F. |
| Sage (Sweet herbaceous sage woody) | 151 | F. |
| Sandalwood (Dry fruity woody) | 183 | F. |
| Sandalwood (Dry woody sandalwood musky) | 180 | F. |
| Sandalwood Syn (Thick sweet sandalwood musk) | >200 | F. |
| Sandalwood Vanilla (Sweet dry woody sandal.) | >200 | F. |
| Sea Breeze (Sweet citrus fresh seashore) | 155 | F. |
| Sea Breeze (Dry green ocean floral) | 152 | F. |
| Sex on the Beach (Sweet tropical fruity) | 170 | F. |
| Smore's (Chocolate marshmallow graham cracker) | >200 | F. |
| Snicker Doodle (Sweet vanilla spicy cookie) | 158 | F. |
| Snicker's Bar (Chocolate caramel peanuts) | >200 | F. |
| Spearmint (Strong warm rich green spearmint) | 145 | F. |
| Spearmint Vanilla (Sweet warm vanilla spearmint) | 165 | F. |
| Spice (Cinnamon clove) | 182 | F. |
| Spice Cake (Sweet cinnamon vanilla cake) | 180 | F. |
| Spiced Pear (Sweet cinnamon clove fresh pear) | 173 | F. |
| Spring Flowers (Sweet neroli lily honeysuckle) | 170 | F. |
| Spring Flowers (Sweet lilac lily jasmine wisteria) | >200 | F. |
| Spring Garden (Strong green citrus hyacinth) | 140 | F. |
| Spring Mint(Sweet magnolia spearmint peppermint) | 190 | F. |
| Spring Rain (Fresh clean citrus sl. rosy floral) | 173 | F. |
| St. John's Wort (Sweet heady herbaceous floral) | 150 | F. |
| Strawberries & Cream (Sweet vanilla strawberry) | 195 | F. |
| Strawberry (Sweet strawberry jam) | 182 | F. |
| Strawberry (Sweet rich heavy strawberry seed) | >200 | F. |
| Strawberry Cheesecake (Tart strawberry) | 198 | F. |
| Strawberry Mint (Strong sweet strawberry mint) | 175 | F. |
| Strawberry Splash (Sweet straw. champagne) | 160 | F. |
| Strawberry Syrup (Very sweet syrupy straw.) | 175 | F. |
| Sugar Cookie (Sweet vanilla cookie) | 180 | F. |
| Sugar Cookie (Very sweet vanilla cookie) | >200 | F. |
| Sugar Cookie Dough (Very sweet vanilla) | 164 | F. |
| Sugar Melon (Sweet green fresh melon) | 170 | F. |
| Sugared Plums (Strong sweet fruity cherry plum) | 150 | F. |
| Sugar Plum Spice (Sweet spicy fruity plum) | 155 | F. |
| Sunflowers (Warm sweet spicy floral) | 199 | F. |
| Sweet Cucumber (Sweet vanilla green cucumber) | >200 | F. |
| Sweetgrass (Heavy sweet woody herbaceous) | >200 | F. |
| Sweetheart Candy (Sweet vanilla spicy floral) | 172 | F. |
| Sweetpea (Strong sweet spicy floral) | >200 | F. |
| Swiss Chocolate (Sweet vanilla milk chocolate) | >200 | F. |
| Tangerine (Strong sweet tangerine orange) | 148 | F. |
| Tangerine Ginger (Sweet tangerine orange ginger) | 145 | F. |
| Tea Rose (Strong sweet fresh spicy red rose) | 205 | F. |
| Tequila Sunrise (Sweet fruity orange cherry) | 160 | F. |
| Toasted Coconut (Sweet vanilla nutty coconut) | 148 | F. |
| Tobacco (Sweet pipe tobacco) | >200 | F. |
| Tropical (Sweet pineapple fruity coconut) | 146 | F. |
| Tuberose (Strong sweet rose ylang tuberose) | 150 | F. |
| Tulip (Strong sweet lily muguet honeysuckle floral) | 192 | F. |
| Turkish Mocha (Strong coffee chocolate vanilla) | 168 | F. |
| Ultra Vanilla (Powerful sweet vanilla extract type) | 175 | F. |
| Vanilla (Sweet vanilla sugar) | 142 | F. |
| Vanilla (Sweet vanilla extract) | 182 | F. |
| Vanilla (Sweet vanilla cake) | 199 | F. |
| Vanilla Crunch (Sweet creamy vanilla caramel) | >200 | F. |
| Vanilla Hazelnut (Sweet vanilla spicy nutty) | 152 | F. |
| Vanilla Pine (Sweet vanilla pine fir) | 170 | F. |
| Victorian Christmas (Sweet fruity woody floral) | >200 | F. |
| Victorian Rose (Strong green spicy rose) | >200 | F. |
| Violet (Sweet violet floral) | 198 | F. |
| Violet (Strong sweet spicy violet) | 178 | F. |
| Warm Sugar Vanilla (Sweet spicy oriental vanilla) | 200 | F. |
| Wassail (Lemon orange vanilla spice) | 148 | F. |
| Water Lily (Sweet lily rose floral) | >200 | F. |
| Watermelon (Strong fresh watery melony fruity) | 148 | F. |
| Wedding Cake (Sweet vanilla spicy cake) | 148 | F. |
| White Ginger (Sweet spicy ginger) | >200 | F. |
| White Rose (Sweet spicy white rose) | >200 | F. |
| Wild Cherry (Sharp fruity cherry) | 138 | F. |
| Wild Flower (Earthy green floral) | 175 | F. |
| Wine & Roses (Just like it sounds) | 140 | F. |
| Winterberry (Green spicy powdery floral) | 179 | F. |
| Wintergreen (Strong sweet wintergreen mint) | >200 | F. |
| Wisteria (Strong sweet powdery floral) | 189 | F. |
| Ylang (Strong sweet spicy ylang floral) | 180 | F. |

The present invention includes one or more of the following examples. In order to develop a robust process with a wide variety of applications using a wide variety of the available scent, the scents selected were chosen at random out of a possible 4000. It was found that in some applications, e.g., clear scented gel carriers, the longevity and durability of the scented gel carrier was improved by allowing the mixture to set for 24 hours prior to use. As used in screen printing, the examples below used a squeegee method of screen printing using a 70/90/70 triple durometer technique. To increase the consistency and usefulness of the results, all scented substrates were allow to air cure for 24 hours before laundry cycle tests, however, the scented gel carrier may be allowed to cure for more or less time depending on the type of scent and matrix used to form the gel.

### EXAMPLE 1

A scented gel carrier was created in which a scent was added to a high-density clear ink, however, the viscosity of the ink was lowered to a point in which the mixed clear gel ink and scent leached to the usable surface. In this example, 100 parts gel were mixed with 20 parts scent in a solvent base with a flash point of less than 200 Fahrenheit. During the curing process the dwell time was of one minute at 320 F. The scented gel was passed through a 60-109 screen mesh count that had been stretched to 20 Newtons with a 200 microns capillary film. The result was a scented gel carrier that not only leached but that did not retain a great amount of scent. This mixture, however, may find use for applications in which a lesser degree of scenting is required and in which leaching is desired, e.g., tie-dye application.

### EXAMPLE 2

A scented gel carrier was created in which a scent was added to a high-density clear ink, however, the viscosity of the ink was lowered to a point in which the mixed clear gel ink and scent leached to the usable surface. To increase the viscosity and reduce leaching, a thickener was added to the gel carrier. The thickener succeeded in controlling most of the leaching but failed to achieve the desired level of scent released due to the length of exposure to temps above 200 degrees F. In this embodiment, 100 parts gel were mixed with to 20 parts scent solvent base with a flash point of less than 200 F, with to five to seven parts thickener. The curing was conducted with a dwell time of one minute cure temperature 320 F. A screen with a 60-109 mesh count was stretched to 20 Newton with a 200 micron capillary film.

### EXAMPLE 3

A scented gel carrier was created in which a scent was added to a high-density clear ink. To increase the retention of scent, a catalyst was added to the scent and matrix that would decrease cure dwell time to 45 seconds and cure temperature to 200 F, The resulting scented gel carrier increased the residual scent to a minimum of laundry cycles but failed to retain the desired level of scent. In this embodiment, 100 parts gel were mixed with 20 parts scent in a solvent base with a flash point of less than 200 F, with five to seven parts thickener and five parts catalyst. A screen mesh count of 60-109 was used, stretched to 20 Newtons and using a 400 microns capillary film to increase the thickness of the cured scented gel matrix.

### EXAMPLE 4

A scented gel carried was made by mixing the scent with a non-solvent base that would allow for increased dwell time, to secure more scent through additional curing and increasing the flash point. A cured scented gel matrix was achieved that provided the required scenting and washing durability, which was tested as a substrate that held at 4 to 6 inch from the nose after being washed six 6 times in a normal wash cycle in cold water with a mild detergent followed by air drying. The scented gel carrier included 100 parts gel to 20-40 parts per scent in “H” base with a flash point of up to 350 F. In addition, five to seven parts thickener to two parts catalyst may be added to increase the dwell time and decrease leaching. In this example, a dwell time of one minute was used at 275 F. The mesh count used was 130-160, stretched to 25-30 Newton and using a 200 micron capillary film.

### EXAMPLE 5

A number of scents were picked randomly for use as compositions with the method of the present invention to show: (1) that any type of scent could be adapted for use as a scented gel carrier; and (2) that the method was robust and repeatable. In this embodiment, 100 parts gel (“H” base) were mixed with about 20-40 parts of scent with a flash point up to 350 F to five to seven parts thickener to two parts catalyst. The scented gel carrier may be further seasoned to improve the retention of the scent following curing of the scented gel matrix after deposition onto the substrate by allowing the mixture to season for, e.g., 1, 2, 4, 6, 12, 24 or even 36 hours prior to application. It was found that while some very light leaching occurred intermittently, the cured scented gel matrix achieved the required scenting and washing durability, which was tested as a substrate that held at 4 to 6 inch from the nose after being washed six 6 times in a normal wash cycle in cold water with a mild detergent followed by air drying. A dwell time of one minute was used at 275 F, a screen had a mesh count of 130-160; stretched to 25-30 Newton and a 200 micron capillary film. The scented gel carrier was able to maintain a scent after six wash/dry cycles, at a nose range of three to six inches.

### EXAMPLE 6

To stop leaching in the printed substrate, a base of gel tinted with pigment to the exact color of substrate was deposited prior to depositing the scented gel carrier. Also, the capillary film was increased to 800 microns (standard screen-print is about 200 microns), and the screen was stretched to 30-50 Newtons (standard screen-print is about 20 Newtons), with a screen mesh count 155 (standard screen-print is about 60 to 109). The scented gel carrier was deposited and cured with a dwell time of 1 about minute at 275 F. This scented gel carrier used 100 parts gel to about 20-40 parts per scent in “H” base with flash point up to 350 F. Also added were five to seven parts thickener to two parts catalyst. No leaching was observed and the cured scented gel matrix achieved the required scenting and washing durability, which was tested as a substrate that held at four to six inch from the nose after being washed six times in a normal wash cycle in cold water with a mild detergent followed by air drying.

It can be seen from the foregoing that the principles of the invention can be used on articles after they have been otherwise completed as to manufacture and ready for marketing. For example, a sock that has already been processed to provide a design on the sole of the sock thereby providing both a scented article but also additional cushion and/or grip. The scented gel carrier may be applied before during or after the sock is processed and may be applied in a high throughput machine, e.g., a dispensed onto a continuously moving sheet in a high speed manufacturing line by, screen printing or even spraying. Significant value can thus be added to the products of a third party without complicated or expensive procedures.

While the features of the invention have been described in connection with the use of the inner surface of an article, those skilled in the art may prefer to apply the scented composition to the outer or visible surface of the article, or on both the front and back surfaces of the material of the article.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A gel comprising a scent and a matrix to form a scented gel, wherein the scented gel maintains its scent after one or more washes in cold water and mild detergent.

2. The gel of claim 1, wherein the scent comprises a water-soluble scent.

3. The gel of claim 1, wherein the scent comprises an oil-soluble scent.

4. The gel of claim 1, wherein the scent comprises an alcohol-soluble scent.

5. The gel of claim 1, wherein the scent is a multi-component scent mixture.

6. The gel of claim 1, wherein the scent and polymer matrix is permanent.

7. The gel of claim 1, wherein the matrix comprises one or more monomers that are catalyzable into a polymer.

8. The gel of claim 1, wherein the matrix comprises a plastisol gel and a hydrogenated rosin resin.

9. The gel of claim 1, wherein the scent and matrix is cured at less than 200 degrees Fahrenheit.

10. The gel of claim 1, wherein the scent has a flashpoint that is less than the curing temperature of the matrix.

11. The gel of claim 1, wherein the scent and matrix is colorless.

12. The gel of claim 1, further comprising a color.

13. The gel of claim 1, further comprising an antifungal agent.

14. The gel of claim 1, further comprising an antibacterial agent.

15. The gel of claim 1, wherein the matrix is adapted for deposition from between about 5 to about 800 microns.

16. The gel of claim 1, wherein the scent and the matrix are provided in a ratio from about 1:50 to about 50:1 (v/v), respectively.

17. The gel of claim 1, wherein the matrix comprises an “H” base polymer.

18. The gel of claim 1, wherein the scented gel has a ratio of about 100 parts matrix to about 2 to about 40 parts scent wherein the scented gel has a flash point of up to about 350 Fahrenheit and further comprising about 5 to about 7 parts of a thickener and about 2 parts catalyst.

19. A scented article comprising:
a substrate; and
a scented gel disposed on or about the substrate comprising a scent and a polymer matrix, wherein the cured scented gel maintains its scent following one or more washes in cold water and mild detergent.

19. The scented article of claim 19, wherein the substrate is selected from the products listed in Table 1.

20. The scented article of claim 19, wherein the scented gel is deposited on a substrate with a thickness of between about 5 and about 800 microns.

21. The scented article of claim 19, wherein the substrate has disposed thereon a design.

22. The scented article of claim 19, further comprising a protective layer that is deposited between the substrate and the scented gel.

23. The scented article of claim 19, further comprising a protective layer that is deposited on the scented gel.

24. The scented article of claim 19, wherein the substrate has a first surface that is generally not visible and the scented gel is deposited on the first surface.

25. The scented article of claim 19, wherein the scented gel has a ratio of about 100 parts matrix to about 2 to about 40 parts scent wherein the scented gel has a flash point of up to about 350 Fahrenheit and further comprising about 5 to about 7 parts of a thickener and about 2 parts catalyst.

26. The scented article of claim 18, wherein the scented gel carrier is deposited using a high speed printing machine.

27. A method for preparing a scented gel carrier, comprising the steps of:
mixing one or more scents with a matrix to form a scented gel carrier; and
allowing the mixture to season for at least about one hour, wherein the resulting seasoned mixture when cured onto a substrate maintains a scent for at least about one week.

28. The method of claim 27, wherein the scented gel carrier may be dispensed onto a continuously moving sheet in a high speed manufacturing line.

30. The method of claim 27, wherein the scented gel carrier has sufficient mechanical integrity to retain its shape under ambient conditions; releases a scent in a manner that substantially preserves the native scent upon release; and may be provided to continuous process in a high speed line.

31. The method of claim 27 wherein the scented gel carrier comprises a ratio of about 100 parts matrix to about 2 to about 40 parts scent wherein the scented gel has a flash point of up to about 350 Fahrenheit and further comprising about 5 to about 7 parts of a thickener and about 2 parts catalyst.

32. The method of claim 27, wherein the adhesive comprises a hydrogenated rosin resin.

33. The method of claim 27, wherein the scented gel carrier comprises 100 parts gel to 20 to 40 parts per scent in a hydrogenated methyl ester rosin resin with a flash point of up 350 F.

34. The method of claim 27, wherein the scented gel carrier is allowed to season for at least about one hour prior to application onto a substrate.

35. The method of claim 27, wherein the scented gel carrier is cured at about 275 F for at least about 15 seconds.

36. The method of claim 27, wherein the scented gel carrier is cured at about 275 F for at least about 15 seconds and the resulting cured scented gel carrier maintains a scent after at least two washes in cold water followed by air drying.

37. A method of applying a scent to an article, comprising the steps of;
applying a scented gel carrier to a substrate; and
curing the scented gel carrier at a temperature that is at about or less than the flashpoint of the scent.

38. The method of claim 37, further comprising applying a protective coating to the substrate.

39. The method of claim 37, further comprising applying a protective coating to the scented gel carrier.

40. The method of claim 37, wherein the scented gel carrier is applied to the substrate by spraying.

41. The method of claim 37, further including the step of applying the scented gel carrier on a surface of the substrate that is not generally visible during use of the article.

44. The method of claim 37, wherein the scented gel carrier is colorless.

45. The method of claim 37, wherein the scented gel carrier is applied to the substrate by screen printing.

46. An article of manufacture made in accordance with the method of claim 37.
